(19) United States
(12) Patent Application Publication
(10) Pub. No.: US 2006/0064576 A1
(43) Pub. Date: Mar. 23, 2006

(54) Boot systems and methods

(75) Inventor: Chao-Hung Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/042,633

(22) Filed: Jan. 25, 2005

(30) Foreign Application Priority Data
Sep. 22, 2004 (TW) 93128684

(51) Int. Cl. G06F 9/24; G06F 15/177; G06F 9/445; G06F 9/00

(52) U.S. Cl. 713/2

(57) ABSTRACT

Boot systems and methods. The system comprises a memory, a block storage device, and a boot loader. The block storage device stores at least an executable image, such as an operating system image, and a boot info file recording at least a location of the executable image in the block storage device, a length of the executable image, and a starting location of the executable image to be written to the memory. When the embedded system boots, the boot loader reads the boot info file, reads the executable image from the block storage device according to the location of the executable image in the block storage device and the length of the executable image, and writes the executable image to the memory from the starting location.

### BACKGROUND

The present disclosure relates generally to a boot management, and more particularly, to boot systems and methods.

There are two types of memory, classified by access type, parallel memory and serial memory. Parallel memory may be a NOR type flash. Serial memory is also referred to as block storage device, such as NAND type memory. Since parallel memory can be accessed via a parallel output/input interface, its access rate is higher than that of serial memory. Since the parallel memory allows the host to access the minimum unit, such as bytes of the memory, the parallel memory is always adopted as the system memory for computer systems and is used to store program data. Therefore, computer systems are able to perform XIP (execute-in-place) in the parallel memory. Serial memory, such as data flash and hard disc, however, is always used as back up data. Since the serial memory provides the host access to a fixed block size, the computer systems cannot perform XIP therein.

With convenience and functionality improvements in portable devices, such as embedded systems including PDAs, mobile phones, smart phones, and others, portable devices have become widely used. An embedded system always comprises a system memory and a block storage device storing an executable image. Since the block storage device cannot provide XIP, when the executable image is to be executed, the executable image must first be copied from the block storage device to the system memory, and pointed up a program counter of the CPU (Central Processing Unit) to the location of the executable image in the system memory. Similarly, a boot loader of the embedded system must load an OS (Operating System) image from the block storage device to the system memory when the embedded system boots. It is understood that the boot loader must determine the location of the executable image to be stored in the system memory, and determine the location of the executable image to be executed according to the starting address of the executable image, such that the OS can be correctly executed in the embedded system.

Since the size of the OS image is based on the language version, the attached software and drivers of the embedded system, for maximum utilization of the system memory, the starting address of the OS image must be adjusted accordingly. Additionally, if the size of the system memory is changed, the starting address of the OS image must also be adjusted accordingly. The conventional boot mechanism of embedded systems, however, hard codes the starting address of the OS image in the boot loader, causing higher dependency on the boot loader and the OS image, such that the boot loader and the OS image cannot be developed independently. When the OS version is changed or system memory of the embedded system is extended, additional resources and time are required to update the corresponding boot loader. Further, there is an issue of version control between the boot loader and the OS image. Since the conventional boot mechanism lacks version verification capability, stability and reliability of the embedded system are affected.

### SUMMARY

Boot systems and methods, and OS image construction methods are provided. An exemplary embodiment of a boot system for use in an embedded system comprises a memory, a block storage device, and a boot loader. The block storage device stores at least an executable image, such as an OS image, and a boot info file which records at least a location of the executable image in the block storage device, a length of the executable image, and a starting location of the executable image to be written to the memory. When the embedded system is switched on, the boot loader reads the boot info file, reads the executable image from the block storage device according to the location of the executable image in the block storage device and to the length of the executable image, and writes the executable image to the memory from the starting location.

In an exemplary embodiment of a boot method, a boot info file is read from a block storage device. The boot info file records at least a location of an executable image in the block storage device, a length of the executable image, and a starting location of the executable image required to be written to memory. The executable image is read according to the location of the executable image in the block storage device and the length of the executable image recorded in the boot info file, and the executable image is written to the memory from the starting location recorded in the boot info file.

In an exemplary embodiment of an OS image construction method, a system configuration file of an embedded system is generated. The system configuration file designates at least one feature. Then, source codes and library files are linked and compiled according to the system configuration file and a make file, and an OS image is generated according to the compiled source codes and library files, and a package setting file. Then, a boot info file is extracted from the package setting file. The boot info file records at least a location of the OS image in a block storage device, a length of the OS image, and a starting location of the OS image required to be written to memory.

Boot methods and OS image construction methods may take the form of program code embodied in a tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a boot system;

FIG. 2 is a schematic diagram illustrating an embodiment of a method for generating an executable image;

FIG. 3 is a schematic diagram illustrating an embodiment of a method for generating a boot info file;

FIG. 4 shows an example of a data structure of a boot info file;

FIG. 5 is a flowchart of an embodiment of a boot method;

FIG. 6 is a schematic diagram illustrating an embodiment of a storage medium storing a computer program for execution of a boot method; and

FIG. 7 is a flowchart of an embodiment of an OS image construction method.

### DESCRIPTION

Boot systems and methods, and OS image construction methods are provided.

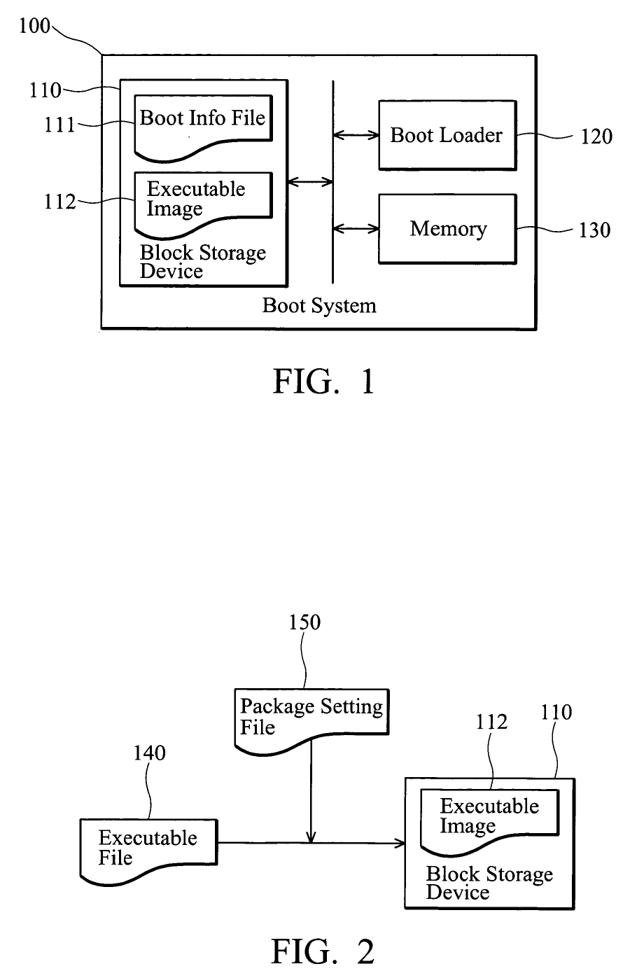

FIG. 1 is a schematic diagram illustrating an embodiment of a boot system. The boot system 100 may be a processor-based electronic device, such as a computer system, and an embedded system, such as a PDA, a mobile phone, and a smart phone. The boot system 100 comprises a block storage device 110, a boot loader 120, and a memory 130.

The block storage device 110 may be a NAND type memory or a hard disc, providing block access type. The block storage device 110 stores at least a boot info file 111 and an executable image 112, such as an OS image. The sub-filename of the executable image 112 is always .BIN or .NB0. The boot loader 120 is a small program executed before an OS kernel. The boot loader 120 initializes hardware, establishes memory mapping, and loads the OS image into system memory for execution. The memory 130 is a data storage device, such system memory having XIP capability.

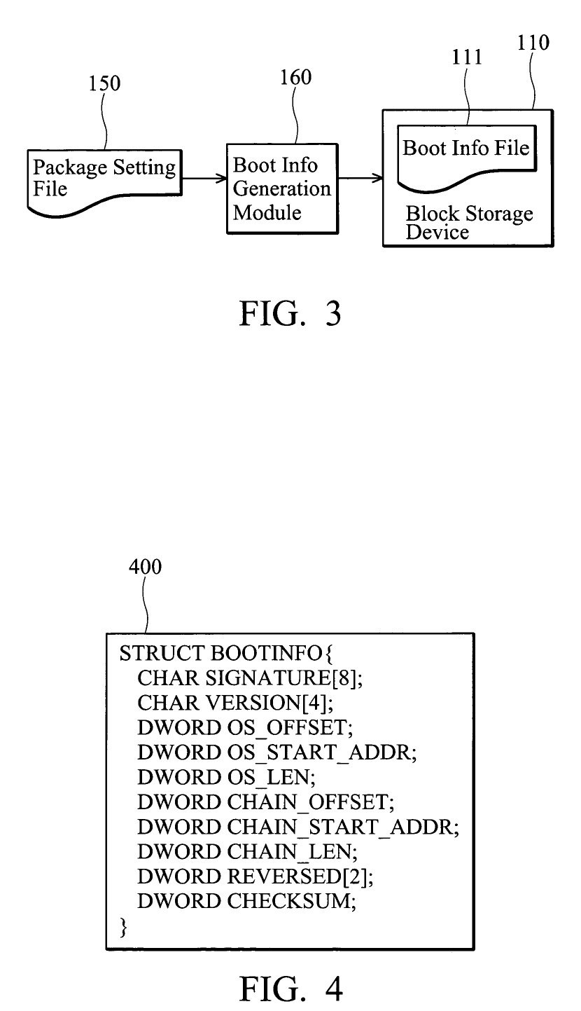

FIG. 2 is a schematic diagram illustrating an embodiment of a method for generating an executable image. The execution location of an executable file 140 generated by compiling source codes in the memory 130 can be set via a package setting file 150, such as a configuration file. The executable file 140 is packaged as an executable image 112 according to the package setting file 150. The executable image 112 is stored to the block storage device 110. FIG. 3 is a schematic diagram illustrating an embodiment of a method for generating a boot info file. The boot system 100 further includes a boot info generation module 160. The boot info generation module 160 parses the package setting file 150 to obtain a boot info file 111, and writes it at a specific location of the block storage device 110.

FIG. 4 shows an example of a data structure 400 of a boot info file, in which “BOOTINFO” is the filename of the boot info file 111. The boot info file 111 records signature information (data of “SIGNATURE” in data structure 400), version information (data of “VERSION” in data structure 400), a location of the executable image 112 in the block storage device 110 (data of “OS_OFFSET” in data structure 400), a starting location of the executable image 112 to be written to the memory 130 (data of “OS_START_ADDR” in data structure 400), a length of the executable image 112 (data of “OS_LEN” in data structure 400), a location of a chain image in the block storage image 110 (data of “CHAIN_OFFSET” in data structure 400), a starting location of the chain image to be written to the memory 130 (data of “CHAIN_START_ADDR” in data structure 400), a length of the chain image (data of “CHAIN_LEN” in data structure 400), and a checksum value (data of “CHECKSUM” in data structure 400). It is understood that if the boot system 100 requests a demand paging function, “CHAIN_OFFSET”, “CHAIN_START_ADDR”, and “CHAIN_LEN” in data structure 400 are used to store related information of the chain image. If the boot system 100 does not request a demand paging function, “CHAIN_OFFSET”, “CHAIN_START_ADDR”, and “CHAIN_LEN” for chain image can be removed from the data structure 400. Demand paging and chain image are well-known in operating systems, and thus omitted here. Additionally, “RESERVED” in data structure 400 is used for further extension.

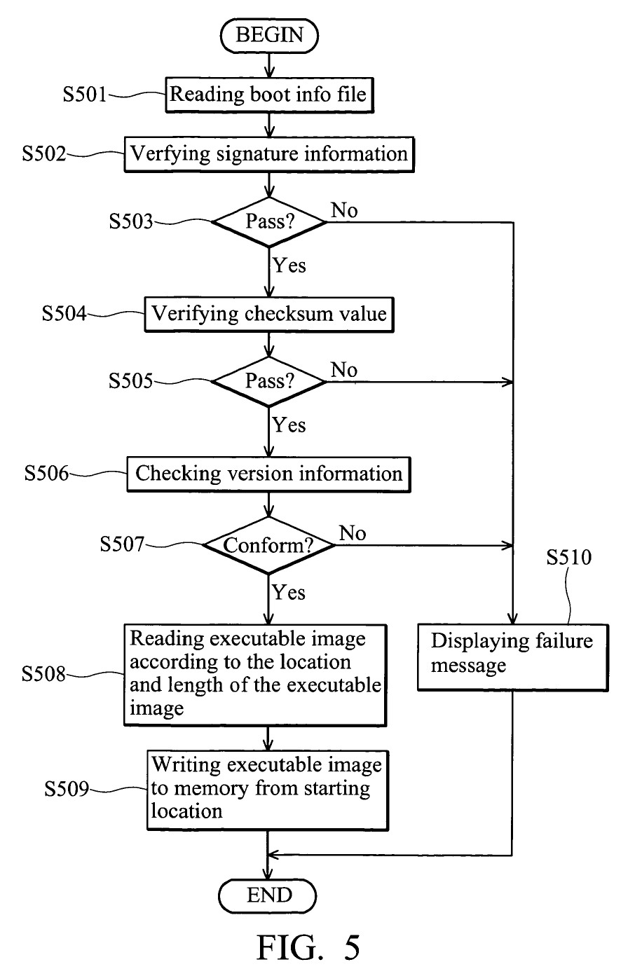

FIG. 5 is a flowchart of an embodiment of a boot method. The boot method is suitable for use in an embedded system. When the embedded system is turned on, in step S501, the boot loader 120 reads the boot info file 111 from the block storage device 110. Similarly, the boot info file 111 records signature information, version information, a location of the executable image 112 in the block storage device 110, a starting location of the executable image 112 to be written to the memory 130, a length of the executable image 112, and a checksum value.

Then, in step S502, the boot loader 120 verifies the signature information in the boot info file 111. If the signature verification does not pass (“No” in step S503), in step S510, a failure message is displayed, and the procedure is terminated. If passed (“Yes” in step S503), in step S504, the boot loader 120 calculates the checksum of the boot info file 111, and verifies the checksum value in the boot info file 111 accordingly. If the checksum verification does not pass (“No” in step S505), in step S510, a failure message is displayed, and the procedure is terminated. If passed (“Yes” in step S505), in step S506, the boot loader 120 checks the version information in the boot info file 111. If the version information does not conform to a predefined version (“No” in step S507), in step S510, a failure message is displayed, and the procedure is terminated. If so (“Yes” in step S507), in step S508, the boot loader 120 reads the executable image 112 from the block storage device 110 according to the location of the executable image in the block storage device and to the length of the executable image recorded in the boot info file 111, and in step S509, writes the executable image 112 to the memory 130 from the starting location recorded in the boot info file 111. After the OS image 112 is loaded to the memory 130, the OS image 112 can be executed to manage the embedded system.

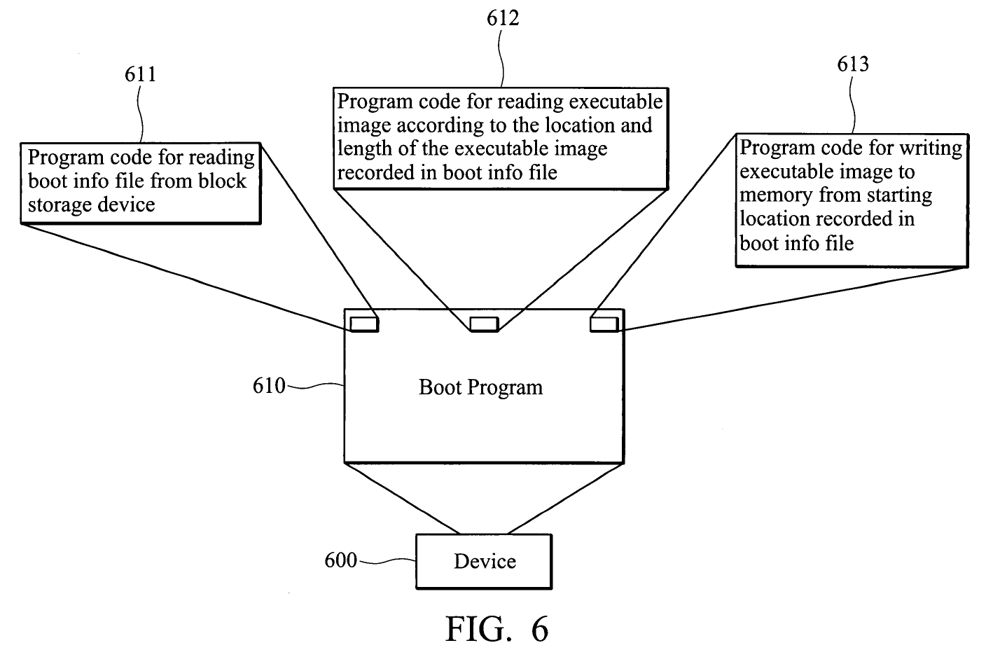

FIG. 6 is a schematic diagram illustrating an embodiment of a storage medium storing a computer program for execution of a boot method. The computer program product comprises a storage medium 610 storing computer readable program code for use in a device 600, such as a computer system or an embedded system. The computer readable program code comprises at least computer readable program code 611 reading a boot info file from a block storage device, in which the boot info file records at least a location of an executable image in the block storage device, a length of the executable image, and a starting location of the executable image to be written to memory, computer readable program code 612 reading the executable image according to the location of the executable image in the block storage device and the length of the executable image recorded in the boot info file, and computer readable program code 613 writing the executable image to the memory from the starting location recorded in the boot info file, thus booting the device.

The computer readable program code further comprises computer readable program code (not shown in FIG. 6) parsing a package setting file to obtain the boot info file, setting an executing location of an executable file in the memory according to the package setting file, and packaging the executable file as a executable image. The computer readable program code further comprises computer readable program code (not shown in FIG. 6) verifying signature information in the boot info file, and if the verification does not pass, stopping loading the executable image to the memory. The computer readable program code further comprises computer readable program code (not shown in FIG. 6) verifying a checksum value in the boot info file, and if the verification does not pass, stopping loading the executable image to the memory. The computer readable program code further comprises computer readable program code (not shown in FIG. 6) verifying version information in the boot info file, and if the verification does not pass, stopping loading the executable image to the memory

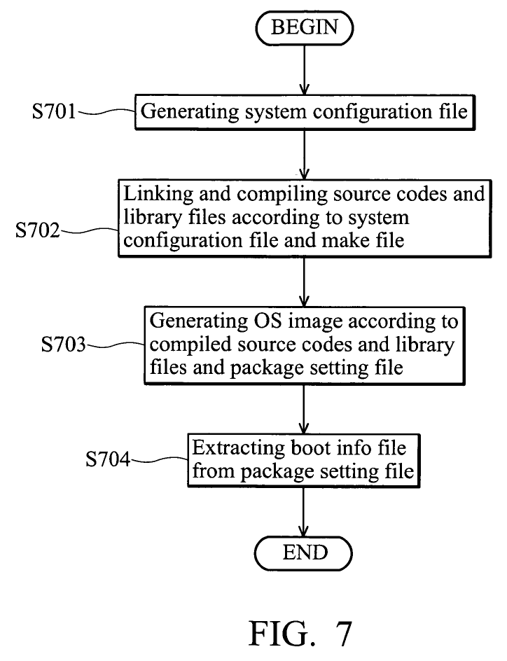

The generation procedure of the boot info file can be integrated into the construction procedure of the OS image. FIG. 7 is a flowchart of an embodiment of an OS image construction method. It is understood that Window CE is used as an example in the embodiment. First, a system configuration file of an embedded system is generated. The system configuration file designates at least one feature. In this step, specific files are converted to a format conforming to the system requirement. These files are classified into four types: .bib files describing Windows CE files involved in the OS image, .dat files describing a file system, such as a storage location of a specific file, .db files describing a Windows CE .NET object storage database, and .reg files indicating system register tables. Then, in step S702, source codes and library files are linked and compiled according to the system configuration file and a make file. The system recognizes the source codes required to be compiled, and corresponding compiler rules according to the make file. Then, in step S703, the compiled source codes and library files are copied to a specific directory, and the OS image is generated according to the compiled source codes, library files, and a package setting file. Then, in step S704, a boot info file is extracted from the package setting file. The boot info file records at least a location of the OS image in a block storage device, a length of the OS image, and a starting location of the OS image to be written to memory. After the OS image and the boot info file are generated, they are stored to the block storage device.

Boot methods and OS image construction methods, or certain aspects or portions thereof, may take the form of program code (i.e., executable instructions) embodied in tangible media, such as products, floppy diskettes, CD-ROMS, hard discs, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A boot system for use in an embedded system, comprising:
a memory;
a block storage device storing at least an executable image, and a boot info file recording at least a location of the executable image in the block storage device, a length of the executable image, and a starting location of the executable image to be written to the memory; and
a boot loader, which, when the embedded system boots, reads the boot info file, reads the executable image from the block storage device according to the location of the executable image in the block storage device and the length of the executable image, and writes the executable image to the memory from the starting location.

2. The system of claim 1 further comprising a boot info generation module parsing a package setting file to obtain the boot info file.

3. The system of claim 2 wherein the package setting file defines an execution location of an executable file in the memory, and the executable file is packaged as the executable image according to the package setting file.

4. The system of claim 1 wherein the boot loader further verifies signature information in the boot info file, and stops loading the executable image to the memory if the verification does not pass.

5. The system of claim 1 wherein the boot loader further verifies a checksum value in the boot info file, and stops loading the executable image to the memory if the verification does not pass.

6. The system of claim 1 wherein the boot loader further verifies version information in the boot info file, and stops loading the executable image to the memory if the verification does not pass.

7. The system of claim 1 wherein the executable image comprises an OS (Operating System) image.

8. A boot method, for use in an embedded system, comprising:
reading a boot info file from a block storage device, in which the boot info file records at least a location of an executable image in the block storage device, a length of the executable image, and a starting location of the executable image to be written to memory;
reading the executable image according to the location of the executable image in the block storage device and the length of the executable image recorded in the boot info file; and
writing the executable image to the memory from the starting location-recorded in the boot info file.

9. The method of claim 8 further comprising parsing a package setting file to obtain the boot info file.

10. The method of claim 9 further comprising defining an execution location of an executable file in the memory, and packaging the executable file as the executable image according to the package setting file.

11. The method of claim 8 further comprising verifying signature information in the boot info file, and stopping loading the executable image to the memory if the verification does not pass.

12. The method of claim 8 further comprising verifying a checksum value in the boot info file, and stopping loading the executable image to the memory if the verification does not pass.

13. The method of claim 8 further comprising verifying version information in the boot info file, and stopping loading the executable image to the memory if the verification does not pass.

14. The method of claim 8 wherein the executable image comprises an OS (Operating System) image.

15. A machine-readable storage medium comprising a computer program, which, when executed, causes a device to perform a boot method, the method comprising:
reading a boot info file from a block storage device, in which the boot info file records at least a location of an executable image in the block storage device, a length of the executable image, and a starting location of the executable image to be written to memory;
reading the executable image according to the location of the executable image in the block storage device and the length of the executable image recorded in the boot info file; and
writing the executable image to the memory from the starting location recorded in the boot info file.

16. The storage medium of claim 15 wherein the method further comprises parsing a package setting file to obtain the boot info file.

17. The storage medium of claim 16 wherein the method further comprises defining an execution location of an executable file in the memory, and packaging the executable file as the executable image according to the package setting file.

18. The storage medium of claim 15 wherein the method further comprises verifying signature information in the boot info file, and stopping loading the executable image to the memory if the verification does not pass.

19. The storage medium of claim 15 wherein the method further comprises verifying a checksum value in the boot info file, and stopping loading the executable image to the memory if the verification does not pass.

20. The storage medium of claim 15 wherein the method further comprises verifying version information in the boot info file, and stopping loading the executable image to the memory if the verification does not pass.

21. The storage medium of claim 15 wherein the executable image comprises OS (Operating System) image.

22. An OS image construction method, comprising:
generating a system configuration file of an embedded system, in which the system configuration file designates at least one feature;
linking and compiling source codes and library files according to the system configuration file and a make file;
generating an OS image according to the compiled source codes and library files, and a package setting file; and
extracting a boot info file from the package setting file, in which the boot info file records at least a location of the OS image in a block storage device, a length of the OS image, and a starting location of the OS image to be written to memory.
